(19) United States
(12) Patent Application Publication
(10) Pub. No.: US 2020/0179798 A1
(43) Pub. Date: Jun. 11, 2020

(54) REMOVABLE COVER FOR A CONTROL UNIT

(71) Applicant: SMART GRIP GmbH, Hamburg (DE)

(72) Inventor: K. Deniz WANNENMACHER, Hamburg (DE)

(21) Appl. No.: 15/758,819

(22) PCT Filed: Sep. 7, 2016
(86) PCT No.: PCT/DE2016/000338

§ 371 Date: Mar. 9, 2018

(30) Foreign Application Priority Data
Sep. 10, 2015 (DE) 10 2015 115 235.5

(51) Int. Cl. A63F 13/24; A63F 13/98

(52) U.S. Cl. CPC A63F 13/24; A63F 13/98

(57) ABSTRACT

The invention relates to a removable cover for a control unit which has input devices, in particular for a controller for gaming consoles or PCs, wherein the shape of the cover is precisely adapted to the shape of the control unit regions to be covered and the cover consists of a multilayer sheet material which has at least one textile outer cover layer and one elastic and moisture-absorbing layer. The elastic and moisture-absorbing layer is made of spacer mesh or woven fabric. In this matter, the cover according to the invention is improved with respect to comfort of use and in particular with respect to the moisture-absorbing effect in comparison to known covers, and the cover is also designed to be more user-friendly.

### BACKGROUND

### Technical Field

The present invention relates to a removable cover for a control unit having input devices, in particular for a controller for gaming consoles or PCs, that, with respect to its formation, is adapted in a precisely fitting manner to the form of the regions of the control units which are to be covered and which consists of a multi-layered surface material having at least a textile outer covering layer and an elastic and moisture-absorbing layer.

### Background Information

Control units for controlling programming processes, such as in particular controllers for gaming consoles or PCs, are often used by the respective users in an intensive manner and over a long period. In this regard, in particular users of gaming consoles and PCs should be mentioned, who in some cases pursue their hobby over a period of several hours and play video games or computer games. For example, so-called LAN parties are organized and held, at which gatherings computer gamers play for several hours on consecutive days on networked computers and thereby constantly use and operate the corresponding control units for operating the video games.

Typical modern control units of this kind are formed approximately crescent-shaped with two grip portions and a central portion connecting the two grip portions. Each of the grip portions is held with one hand during gaming. Various input devices such as directional pads, push buttons or switches and so-called analog sticks are operated with the thumbs and/or index fingers, and in some cases also with other fingers of the hands, in order to control gaming processes and to activate actions or functions in the game.

A high level of perspiration on the palms of the hands is often a problem not only due to the ambient temperature and the contact of the palms with the respective control unit, but also due to player tension during playing. As a result of this perspiration, the players lose their firm grip relative to and on the plastic surfaces of the control units and can thus no longer reliably realize the control commands which often need to be carried out in rapid succession and by means of different activation of the individual input devices (switches, push buttons, directional pads, analog sticks and the like), and thus lose control of the game, for example of the heroes and characters guided by them in a computer or video game. Many users and gamers find this very disruptive.

Furthermore, the sweat formed on the palms is destructive with respect to the material of the control units, and not only damages the surfaces thereof but can cause damage and lead to a malfunction, in particular when it penetrates in the region of the input devices and enters the housing of the control units in said regions. This is irritating not only because a new control unit must be procured in such cases, but it is also particularly undesirable for a gamer because this can result in an abrupt end to his game specifically when he is no longer able to realize important steering and control functions which are required to operate the game. Many dedicated gamers therefore even keep replacement control units on hand for such instances of malfunctioning.

In order to solve the problems described here, removable covers which ensure improved grip of the control units and which are also intended to have a sweat-absorbing function have already been proposed. Document EP 1 064 058 B1 for example thus proposed for such a control unit a cover in the grip region, which cover is intended to improve the grip of the control unit during operation and thereby absorb any hand dampness. The cover disclosed therein is drawn over the grip of a control unit in the manner of a sock and is made from a stretchable elastic material. Alternatively, such a cover can also be formed as is a foldaway element and can be laid over the grip portion of the control unit. According to a particular variant of the cover disclosed in this document, the material should be designed to be washable.

Another example of a removable cover for a control unit is disclosed in document EP 0 997 174 A1. The cover disclosed therein presents that, with respect to its formation, a cover that is adapted in a precisely fitting manner to the form of the regions of the control units which are to be covered and which consists of a multi-layered surface material having at least a textile outer covering layer and an elastic and moisture-absorbing layer. It is formed from a material having an elastic surface and is in particular constructed with multiple layers. A top and outermost layer can consist of a material of the kind typically used in the clothing industry, with cotton, jersey fabric or nylon being mentioned herein. A central layer is formed by an elastic material which is able to elastically recover following application of force, with said layer being described as being formed in particular from a foamed, flexible plastic material, and neoprene in particular being mentioned as the material. Alternatively, isoprene is mentioned here as a possible material of this kind. This document furthermore states that the material from which the cover is formed can in to particular be of the kind known from the production of diving suits and wetsuits. A third layer in the form of a layer located on the inner side is described as being made from a material that ensures a non-slip connection with the housing of the control unit. The cover disclosed in this document should likewise be removable and washable.

Furthermore, document GB 249 856 7 discloses a cover for electric devices comprising an outer covering layer, an elastic microfiber inner layer having a pleat design, which has a polishing/cleaning effect on the electric device, and a stiffening element arranged between the outer covering layer and the elastic microfiber inner layer for the physical protection of the electric device.

In addition, documents DE 196 35 170 C1 and DE 43 18 500 A1 disclose that spacer knitted fabrics are particularly suitable for the absorption, storage and, if necessary, the removal of moisture from surfaces and bodies Although the previously known removable covers do address key problems of the kind which exist in conjunction with the use of control units and which are described above, they are not able to solve said problems in an entirely satisfactory manner. This is ultimately also shown by the fact that products associated with the mentioned publications and the technical developments described therein are not commercially available. There is therefore still a need for improvement in order to improve corresponding removable covers with respect to their user comfort and in particular the moisture-absorbing action and thus to make them more user friendly.

### SUMMARY

This problem is solved by the present invention. To this end, the invention further develops a removable cover for a control unit having input devices, in particular for a controller for gaming consoles or PCs, which, with respect to its formation, is adapted in a precisely fitting manner to the form of the regions of the control units to be covered and which consists of a multi-layered surface material, which has at least a textile outer covering layer and an elastic and moisture-absorbing layer, in such a way that the elastic and moisture-absorbing layer is formed by a spacer mesh fabric or spacer woven fabric.

With respect to the elastic and moisture-absorbing layer, elastic shall here be understood to mean in particular elastic in the direction of a surface normal of this layer. Elastic can however—but does not have to—involve an elasticity in at least one direction lying within the surface of the layer.

A spacer mesh fabric or spacer woven fabric is a fabric product made from threads or filaments, generally of a textile nature, which is formed by means of meshing, in particular weaving or knitting, or by means of weaving technology and which is formed from two woven or meshed layers which are formed planar and at least one spacer thread which is guided between these layers and connects the layers to one another but also maintains a distance. The spacer thread is typically a relatively rigid thread, often made from a plastic material, in some cases also made from glass fiber, which on the one hand maintains the distance of the two planes, and on the other hand has a certain elasticity and thus determines the elasticity relative to the surface normal of the overall fabric. One example of such a fabric is described in document EP 1 748 097 A1. Such fabrics are typically used as mattress covers, seat covers or for the lining of vehicle interiors, in particular of the so-called vehicle ceiling here. The essential finding of the invention is the use of such a spacer mesh fabric or spacer woven fabric in a manner which is not known per se in the prior art for is the formation of a cover for a control unit. This occurs because the inventor has recognized that such a fabric is particularly well suited for this purpose and results in excellent properties in the end product. As such a fabric is extremely breathable and moisture absorbing on the one hand, and on the other hand, due to its elasticity in the direction of the surface normal and due to its other properties, it provides an excellent surface feel while at the same time having a relatively small thickness measurement of the layer correspondingly formed with this fabric. This makes it possible to obtain on the one hand a cover which is very effective and active with respect to moisture absorption, and which on the other hand has a relatively small layer thickness and thus does not compromise the ease of use of the input device, but instead, due to the moisture-absorbing effect and the excellent aeration produces a very comfortable holding and operating feeling of the control unit equipped with said cover.

With respect to the multilayer or multi-sheet construction of the surface material from which the removable cover is made according to the invention, the textile outer covering layer can in principle be formed by a covering layer of the spacer mesh fabric or spacer woven fabric. However, it is also possible within the scope of the invention, and this is also currently the preferred option, to form the textile outer covering layer by means of a separate textile layer applied to an outer surface of the spacer mesh fabric or spacer woven fabric. Because in this manner this textile outer covering layer can be formed irrespective of the restrictions and parameters which exist for the formation of those outer surfaces of the spacer mesh fabric or spacer woven fabric which face the outer side of the cover. It is thus possible to in particular design the textile outer covering layer in such a way that it produces a particularly pleasant surface feel and additionally reinforces the moisture-absorbing effect of the cover. This can occur for example in that the textile outer covering layer is a pile loop forming textile, such as a terry cloth for example. Such textiles are known for their particularly good moisture-absorbing properties. The outer textile covering layer can also be formed from microfibers or can comprise microfibers, since this material is likewise known for its particularly good moisture-absorbing properties.

In order to ensure a reliable contact of the removable cover on the control unit without any slippage, said removable cover can have an innermost adhering layer lying opposite the outer covering layer and preventing slippage of the cover relative to the surface to be covered with the cover. Such an adhering layer can for example contain a rubber coating, which can in fact be formed planar throughout, but does not have to be. Such rubber coatings or comparable adhesive materials applied only in certain structures and patterns are conceivable, for example in points arranged in a regular or irregular manner, strips guided in undulations or the like.

In order to prevent that, for the removable cover according to the invention, the moisture absorbed by multilayered surface material, here in particular the elastic and moisture-absorbing layer of the spacer mesh fabric or spacer woven fabric, can penetrate as far as the control unit and infiltrate same, a moisture-impenetrable layer is provided arranged on the side lying opposite the outer covering layer of the elastic and moisture-absorbing layer. This layer then functions as a kind of barrier and protects the sensitive control unit from contact with moisture, in particular hand sweat, which, as already mentioned above, can result in serious damage to the control unit commencing with an action on the surface of the housing of the control unit and through to a corrosive action on the sensitive electronic components located in the control unit. Such a moisture-impermeable layer can also be used and can provide therein the advantages mentioned above in covers which have a moisture-absorbing, elastic layer made of a different material than the spacer mesh fabric or spacer woven fabrics described here as advantageous and useable according to the invention, e.g. as in the considered prior art referred to in the form of a foamed material or the like. The moisture-impermeable layer is formed by a coating applied onto another layer of the multilayered surface material or is formed by a film or a membrane, which is appropriately integrated in the multi-layered surface material. As material for this moisture-impermeable layer, in particular polyurethane (PU) is considered, especially when this layer is formed as a coating.

In particular, the cover according to the invention is formed such that, in the state mounted on the control unit, the cover in any case overlaps a part of the input devices of the control unit. This should permit additional protection in particular of sensitive switches or push buttons, such as for example a directional pad or other push buttons or switches, of a corresponding control unit and protection against infiltration of moisture, in particular hand sweat, in these regions. Such a covering of the input devices is in particular possible because, due to the relatively reduced strength or thickness of the cover, which is possible due to the use of the spacer mesh fabric or spacer woven fabric, the corresponding input devices are still graspable or touchable for a user of the control unit and in this respect can be operated without limiting the functioning or the ease of use, even when they are covered by the cover. Such input devices, and in particular input devices like the analog sticks, which are not covered and then can still be activated by the user of the control unit, remain free; here the cover has corresponding recesses in a typical manner. Those regions which are provided with connections, for example for the insertion of a data cable or a charging cable, likewise have recesses.

The cover can additionally have markings preferably in the regions in which, in the state mounted on the control unit, said cover covers input devices of the control unit, and said markings identify the covered control units according to their location, preferably also according to their type. These markings can in particular be colored markings and/or markings which can be recognized haptically. Colored markings should be understood to also include marking which merely provides a contrast in gray shades in black/white. These markings can be imprints on the outer covering layer, designs and enhancements or similar which are appropriately knitted or woven into the outer covering layer or identified in another manner by thread guidance introduced is into the outer textile layer.

The spacer mesh fabric or spacer woven fabric, which is used for the elastic and moisture-absorbing layer of the cover according to the invention, can be for example a spacer knitted fabric or also a spacer crocheted fabric. The cover according to the invention is typically designed such that it has regions into which the control unit can be inserted, and in turn has other regions which are then laid around additional portions of the control unit in the manner of a loop. In order to fix the cover on the control unit, once those regions of the control unit which are to be covered by the cover are complete surrounded, said cover is closed at the formed seam points, for example by means of a zip fastener, by means of push buttons, by a Velcro fastener, by hooks and eyes or similar releasable closure means.

### BRIEF DESCRIPTION OF THE SEVERAL VIEWS OF THE DRAWINGS

Additional advantages and features of the invention shall emerge from the following description of an exemplary embodiment with reference to the attached figures, in which:

FIG. 1 shows a schematic three-dimensional view of a control unit in the to form of a controller;

FIG. 2 shows a view, comparable to the view of FIG. 1, of the control unit with a cover according to the invention;

FIG. 3 shows the control unit equipped with the cover in a view from the rear;

FIG. 4 shows the control unit equipped with the cover in a view from below;

FIG. 5 shows the cover in a view from above;

FIG. 6 shows the cover in a view from the front;

FIG. 7 shows the control unit with the cover drawn over it, but before the closure of the cover, in a view from below;

FIG. 8 shows, arranged next to one another and, in each case, in a three-dimensional view from the top, the control unit (right) and the cover (left), with the cover having markings corresponding to the position of actuation elements on the control unit; and

FIG. 9 shows, in a schematic manner, a cross section through the layers of the material of the cover.

### DETAILED DESCRIPTION

The figures depict a possible exemplary embodiment, in which the invention described in a general manner above can be realized. This exemplary embodiment shall now be described below with reference to the figures. It should be emphasized at this point that the figures are to be seen as purely schematic drawings and are in no way to scale. The depictions also do not necessarily contain all details required for concrete configuration. Such details will naturally be assumed to be present by the person skilled in the art as a result of his own specialist knowledge and will be understood as being present in the figures and the description below.

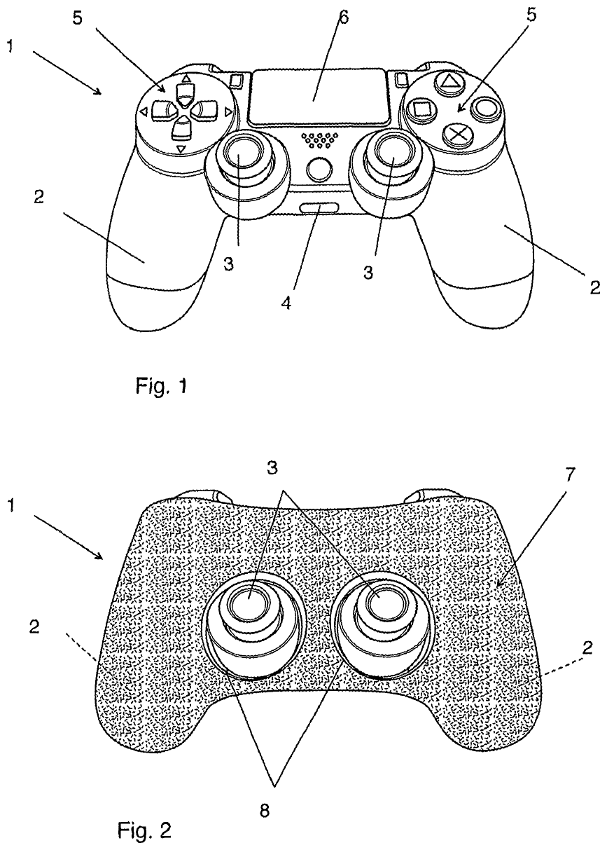

FIG. 1 firstly depicts a three-dimensional view of a controller 1, as is commonly used today for the control of games on gaming consoles or PCs. The controller 1 depicted here has two grips 2 projecting towards the rear in the manner of horns, around which the palms are laid when using the controller 1 in order to thus grasp and hold the controller 1. For the purpose of controlling different gaming functions, the controller 1 is equipped with various input devices. These include in particular two analog sticks 3, which are used by a user of the controller 1 typically with the thumbs of the hands with which the grips 2 are grasped, as well as various control buttons 5 and 10 (compare also FIG. 4). The control buttons 5 can for example be brought together in the manner of a directional pad, as is shown in the arrangement of the control buttons 5 depicted on the left in FIG. 1. Furthermore, other such devices can be provided as input devices, for example a controller 1 shown in FIG. 1 between the arrangements of the control buttons 5 on the left-hand side and a touchpad 6 arranged on the right hand side of the depiction of the figure. A charging socket 4 can additionally be seen, which can be for example a USB charging socket and by means of which an energy store, in particular a battery, arranged in the inside of the controller 1, can be supplied with a charging current.

Controllers like the controller 1 depicted in FIG. 1 are, as already mentioned, sometimes used by computer gamers and video gamers in a very intensive manner to control and configure play processes in computer games or video games. Such devices are often used over very long periods of time with the users, the gamers, very often getting damp hands and developing hand sweat, whether as a result of increased ambient temperature or due to raised adrenalin levels and increased tension and excitement provoked by the game. This moisture not only compromises the strength of the grip with which the controller 1 can be held at the grips 2, it also results in potential damage to the controller 1 itself.

In order to now prevent this from happening, the invention envisages a cover 7, as is depicted in FIG. 2 on a controller 1 and positioned around same. It can be seen that this cover 7 surrounds the controller 1 in a tight manner conforming to the form thereof so that said controller still functions with respect to its ergonomic form and can be firmly grasped by the player. It can also be seen that the cover 7 covers both the control buttons 5 depicted in FIG. 1 and the touchpad 6, that only openings 8 are provided, through which openings the analog sticks 3 project, which are not correspondingly covered by the cover 7. A covering in particular of the control buttons 5 ensures that they are likewise protected against any penetration of moisture and against hand sweat, while they can still be easily and comfortably operated by the user through the cover 7 because the cover 7 itself is tightly fitting on the one hand, and on the other hand is designed to be sufficiently thin in terms of its thickness. The analog sticks 3 by contrast can only be sufficiently reliably operated by the gamer when they are not covered by the cover 7.

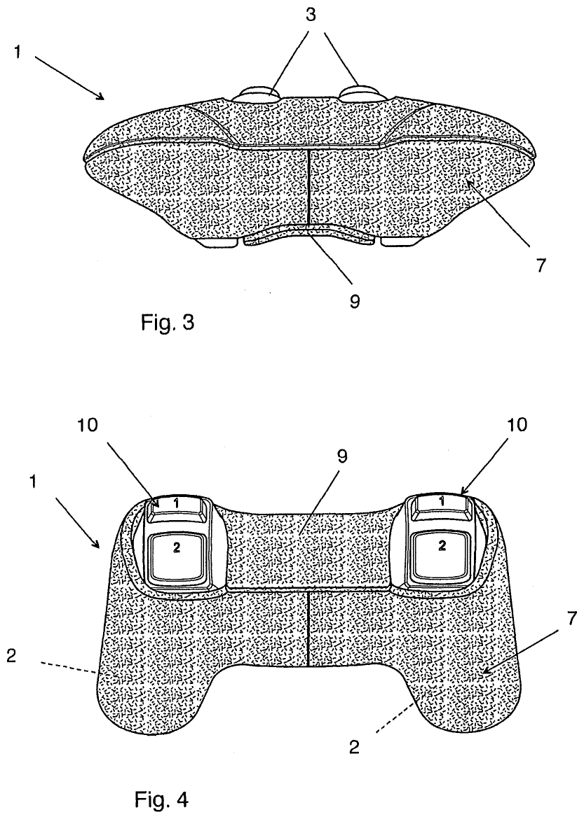

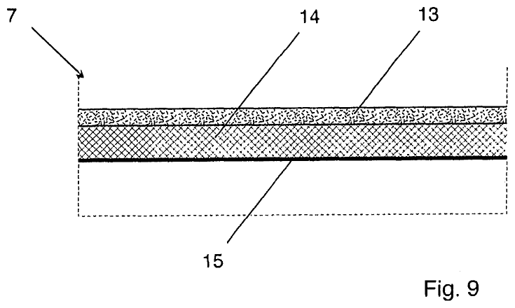

As will be explained below with reference to FIG. 9, the cover 7 is formed multi-layered and has, as the illustration in FIG. 2 and also in the additional FIGS. 3 to 8 shows, a textile outer surface, which is provided with a pile projecting transverse to the surface, for example with loops, like in a terry cloth, or also with an open pile, like in a microfiber fabric for example. This textile outer surface is in particular selected such that it has a high absorptive capacity and can easily and efficiently absorb and remove any moisture, in particular hand sweat.

FIGS. 3 and 4 show the controller 1 equipped with the cover 7 in two additional depictions, namely once from the rear, in other words, viewed from the grips 2 (FIG. 3) and once in a view from below (FIG. 4). These figures additionally show a loop 9—which is closed here, and the additional control buttons 10 arranged on a front face side lying opposite the grips 2 can be seen, which control buttons are operated during the use of the controller 1 with the index fingers of the hands contacting the grips 2.

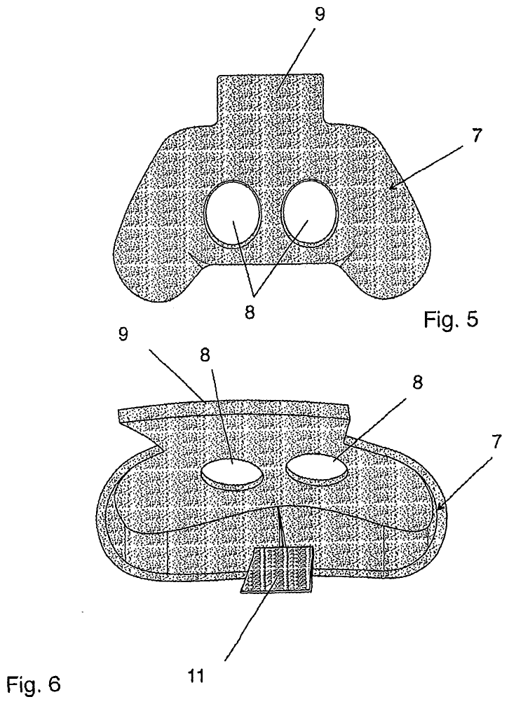

FIGS. 5 and 6 show the cover 7, wherein said cover is not drawn over a controller 1 and connected to same. It can be seen that the cover 7 is formed in the manner of a bag with an opening into which the controller 1 is introduced and inserted, here with the grips 2 entering first. The cutting pattern of the cover 7 is selected such that it is adapted in a tightly fitting manner to the external form of the controller 1, when the latter is introduced into the cover 7. The insertion opening is closed in this exemplary embodiment by means of the loop 9, with a velcro strip 11 being provided here, which is brought together with the loop 9 and then holds said loop in the closed position. Other types of closure are of course also possible, such as for example buttons, push buttons, a zip fastener or the like. In any case the essential thing is that the cover 7 has an opening, which can be closed and opened in order to mount the cover 7 on a controller 1 or in turn to remove it from said controller, in order to replace it and in particular to clean it following a long period of use (for example for washing). The opening of the cover is, in a typical manner, selected with respect to its position such that said opening or a closure thereof in the state mounted on the controller 1 does not project into the gripping region in which a player grasps the controller 1, and thus is not seen as an obstacle.

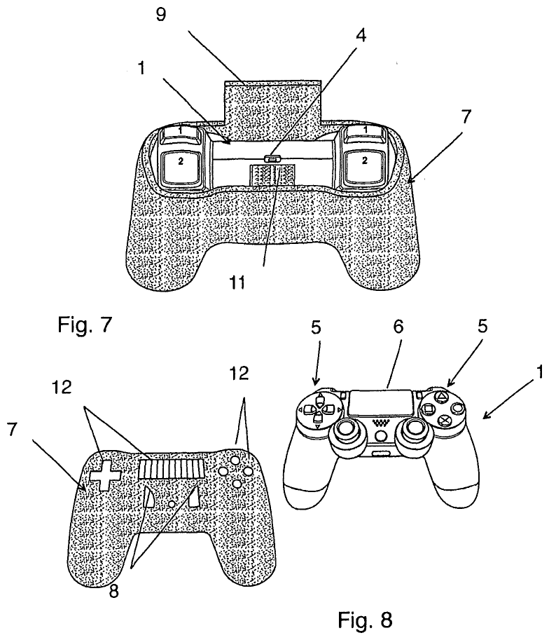

The material from which the cover 7 is produced, preferably has certain surface elasticity, so that it clings tightly in a stretching manner to the controller 1 that it accommodates and surrounds, so that the form of the controller 1 remains the same and can still be perceived by the player. FIG. 7 depicts the controller 1, as inserted into the cover 7 which is opened in the manner of a bag, but without the loop 9 being closed. Clearly visible in this figure are the elements loop 9 and velcro strip 11 which are lying opposite one another, by means of which the cover 7 is closed and secured to the controller 1. Although not depicted here, it is nevertheless preferable that the cover 7 has an additional opening in the region in which the charging socket 4 is arranged, by means of which a charging cable with a connecting plug can be introduced into the charging socket 4. In the exemplary embodiment depicted here, such an opening would be made in the loop 9.

FIG. 8 shows, arranged next to one another, the cover 7 (left) and the controller 1 (right), with the cover 7 here having visible markings 12 which serve to indicate the input units, the control buttons 5 and also the touchpad 6 in the case of a controller 1 arranged in the cover 7 which are arranged at the corresponding points. These markings can be imprinted, flocked or applied in other ways to the textile surface of the cover. The markings can also be stitched into or woven into/knitted into the textile surface of the cover 7.

FIG. 9 depicts a schematic cross section through the multilayer constructed material of the cover 7, which illustrates the construction of the cover 7 according to the invention. This cross section depiction is in particular not to scale, but instead is to be seen merely as a schematic diagram.

The figure shows an outer textile covering layer 13 which is on the outside when the cover is in use, an elastic layer 14 arranged below the covering layer 13, which is elastic in particular also in a direction transverse to the plane of the material of the cover 7 and which is formed in a manner according to the invention by a spacer mesh fabric or spacer woven fabric, and a moisture-impermeable layer 15 formed below the elastic layer 14, in other words, facing an inner side of the cover 7.

The textile covering layer 13 can be formed as a covering layer of the spacer mesh fabric or spacer woven fabric of the elastic layer 14 and to this extent can likewise be a component of this layer. It can however also be produced separately and be attached to the elastic layer 14, for example by means of lamination. The textile covering layer 13 can furthermore be formed in particular with pile loops or open-type pile threads, for example as a terry cloth or also from microfibers so as to thus be able to particularly effectively absorb and transport moisture. The elastic layer 14 formed according to the invention as a spacer mesh fabric or spacer woven fabric is extremely well suited to absorbing and storing moisture thanks to the special design according to the invention, so that the thus formed cover 7 is efficient with respect to keeping the user's hands dry even in the event of a use of long duration. The moisture-impermeable layer 15, which can be for example a coating with a polymer material, for example polyurethane (PU), but also a laminated film-like layer, an inlaid film or membrane or the like, prevents moisture absorbed into and stored in the elastic, moisture-absorbing layer 14 from penetrating further to the controller 1 covered with the cover 7.

The moisture-impermeable layer 14 can optionally be added, and is not absolutely necessary for realizing the invention. In addition, in order to prevent the cover 7 from slipping off the controller 1 and to ensure a tight fit of the cover 7 on the controller 1, it is possible to envisage the provision of structures or elements which provide a hold, which serve as slip protection means. This task can for example also be realized by the moisture-impermeable layer 15, but it is also possible for separated structures or elements to be mounted and provided, such as a rubber coating for example, which can be formed in a continuous manner or in the form of nubs, ribs, corrugations or other structures. Such structures are not depicted in FIG. 9, but would be arranged therein at the lowest depicted position, in other words on the inner side of the cover 7.

### LIST OF REFERENCE NUMERALS

1 controller
2 grip
3 analog stick
4 charging socket
5 control buttons
6 touchpad
7 cover
8 opening
9 loop
10 control buttons
11 velcro strip
12 marking
13 textile covering layer
14 elastic layer
15 moisture-impermeable layer

1. A removable cover for a control unit for gaming consoles or PCs, wherein the control unit has input devices and the control unit is comprised of a multi-layered surface material, that has at least a textile outer covering layer and an elastic and moisture-absorbing layer, wherein the cover, with respect to its formation, is adapted in a precisely fitting manner to a form of one or more regions of the control unit that is to be covered by the cover; wherein the elastic and moisture-absorbing layer is formed by a spacer mesh fabric or a spacer woven fabric, that is a fabric product made from threads or filaments, wherein the spacer mesh fabric or the spacer woven fabric is formed by meshing, in particular weaving or knitting, or by weaving technology; wherein the spacer mesh fabric or spacer woven fabric has two woven or meshed layers that are formed planar; and at least one spacer thread which is guided between the layers and connects the layers to one another but also maintains a distance therebetween, and, wherein the cover has a moisture impenetrable layer arranged on a side lying opposite the textile outer covering layer of the elastic and moisture-absorbing layer, and the moisture impenetrable layer is a coating, a film or a membrane.

2. The cover according to claim 1, wherein the textile outer covering layer is formed by a covering layer of the spacer mesh fabric or the spacer woven fabric.

3. The cover according to claim 1, wherein the textile outer covering layer is a separated textile layer that is mounted on an outer surface of the spacer mesh fabric or the spacer woven fabric.

4. The cover according to claim 1, wherein the textile outer covering layer is a textile forming a pile loop.

5. The cover according to claim 1, wherein the cover further comprises an innermost adhering layer lying opposite the textile outer covering layer and the innermost adhering layer prevents slippage of the cover relative to a surface to be covered with the cover.

6. The cover according to claim 1, wherein the cover is formed such that, in a state of being mounted on the control unit, the cover covers a part of an input device of the control unit.

7. The cover according to claim 6, further comprising markings in the regions in which, in the state of being mounted on the control unit, said cover covers the input device of the control unit, wherein the markings identify the covered control unit according to its location.

8. The cover according to claim 1, wherein the spacer mesh fabric or the spacer woven fabric is a spacer knitted fabric or a spacer crocheted fabric.

9. The cover according to claim 7, wherein the marking are colored markings that are recognizable haptically.

10. The cover according to claim 7, wherein the markings identify the covered control unit according to their type.
